(19) United States
(12) Patent Application Publication
(10) Pub. No.: US 2016/0067531 A1
(43) Pub. Date: Mar. 10, 2016

(54) SYSTEM AND METHOD FOR RESPIRATORS WITH PARTICLE COUNTER DETECTOR UNIT

(71) Applicant: Particles Plus, Inc., Canton, MA (US)

(72) Inventors: David PARISEAU, Los Altos, CA (US); Adam GIANDOMENICO, Sharon, MA (US)

(73) Assignee: PARTICLES PLUS, INC., Canton, MA (US)

(21) Appl. No.: 14/846,642

(22) Filed: Sep. 4, 2015

Related U.S. Application Data
(60) Provisional application No. 62/045,658, filed on Sep. 4, 2014.

(51) Int. Cl. A62B 27/00; A62B 7/00

(52) U.S. Cl. CPC A62B 27/00; A62B 7/00

(57) ABSTRACT

An airborne particle sensor that is intended for use with portable or stationary respirators to provide detection of particulates. This could be used in a number of ways, either continuously or on-demand to provide fit-testing, to validate proper functioning of a respirator, to provide a warning of respirator-failure, to provide notification of filter loading (with integration of pressure sensor), and to provide exposure levels while using the respirator.

### CROSS REFERENCE TO RELATED APPLICATION

This application claims priority to U.S. Provisional Application Ser. No. 62/045,658 filed on Sep. 4, 2014, titled PARTICLE COUNTER/DETECTOR UNIT FOR RESPIRATORS by inventors David PARISEAU et al., the entire disclosure of which is hereby incorporated herein by reference.

### BACKGROUND

Safety agencies like OSHA require yearly fit testing of respirators for employees who use such. This provides a single sample for an entire year and doesn't ensure that the employee's respirator will fit well for that year. Yearly fit testing is also expensive, takes specialized equipment and trained personnel to administer the test. This equipment and personnel are expensive and, as noted, provide sparse sampling. Additionally, such testing doesn't provide any indication of failures or issues while the respirator is in use.

Additionally, medical respirators must also be tested periodically to ensure proper functioning. Therefore what is a needed is a system and method for providing a counter/detector that can be used to simplify the testing process.

### SUMMARY

The invention, based on the various aspects and embodiments, provides a system and method for low cost particulate counter/particle detector for testing respirators and similar devices. As such, these operations are cost-effective to perform and can be administered by personnel without special training. In accordance with various aspects and embodiments of the invention, a particulate counter/detector unit or module is be integrated into such a unit in order to provide on-demand testing (perhaps before use) or real-time monitoring (during use). In accordance with the invention, the system and method include the ability to provide a means of reporting and alerting personnel to respirator or environment interface failures as well performance of a respirator.

### BRIEF DESCRIPTION OF THE DRAWINGS

The following detailed description is directed to certain sample embodiments. However, the disclosure can be embodied in a multitude of different ways as defined and covered by the claims. In this description, reference is made to the drawings wherein like parts are designated with like numerals throughout.

FIG. 1 shows a particle counter in accordance with the various aspects and embodiments of the invention.

FIG. 2 shows a block diagram representation of a respirator in accordance with the various aspects and embodiments of the invention.

FIG. 2A shows various respirators in accordance with the various aspects and embodiments of the invention.

FIG. 3 shows a complex respirator in accordance with the various aspects and embodiments of the invention.

FIG. 3A shows examples of more complex respirators in accordance with the various aspects and embodiments of the invention.

FIG. 4 shows an isolation respirator in accordance with the various aspects and embodiments of the invention.

FIG. 5 shows a dual particle detector unit or system in accordance with the various aspects and embodiments of the invention.

FIG. 6 shows a dual particle detector unit or system in accordance with the various aspects and embodiments of the invention.

### DETAILED DESCRIPTION

In accordance with the invention, it should be observed that the embodiments reside primarily in combinations of method step and apparatus components related to facilitating the invention. Accordingly the components and method steps have been represented where appropriate by conventional symbols in the drawing showing only those specific details that are pertinent to understanding the embodiments of the invention so as not to obscure the disclosure with details that will be readily apparent to those of ordinary skill in the art having the benefit of the description herein.

Unless defined otherwise, all terms used herein have the same meaning as commonly understood by one of ordinary skill in the art to which this invention belongs. Any methods and systems, similar or equivalent to those described herein, can also be used in the practice of the invention. Representative illustrative methods and embodiments of systems are also described in accordance with the aspects of the invention.

It is noted that, as used in this description, the singular forms “a,” “an” and “the” include plural referents unless the context clearly dictates otherwise. Reference throughout this specification to “an aspect,” “one aspect,” “various aspects,” “another aspect,” “one embodiment,” “an embodiment,” “certain embodiment,” or similar language means that a particular aspect, feature, structure, or characteristic described in connection with the embodiment is included in at least one embodiment of the invention. Thus, appearances of the phrases “in one embodiment,” “in at least one embodiment,” “in an embodiment,” “in certain embodiments,” and similar language throughout this specification may, but do not necessarily, all refer to the same embodiment.

The various aspects and embodiments of the invention describe a particulate counter/detector that can be used with respirators both in-situ and as an add-on. As an add-on that can be connected to an existing respirator, it could be used to periodically test respirators or perhaps test the respirator before use. Another possibility is to integrate the particulate counter/detector directly into the respirator and provide for either real-time monitoring of respirator operation, or on-demand sampling and reporting of respirator status. This could provide a user or staff with timely information regarding the proper operation of the respirator, which has significant benefits as outlined herein.

The details on particulate counting/detection are disclosed in Particle Plus, Inc.'s PCT Application No. PCT/US2013/059549, which discusses in detail the implementation of a low-cost particle detector/counter that could easily be adapted to fit this particular application since it provides a solution that is very low-cost while providing good quality results in a reliable design. A particle or particulate counter/detector typically measures the flow rate and sorts the particles detected by air volume and by particle size. Such units are typically calibrated to one or more standards. A particle detector has a more rudimentary architecture and may simply reply on an estimate of air flow and coarsely “sort” particulates into large and small.

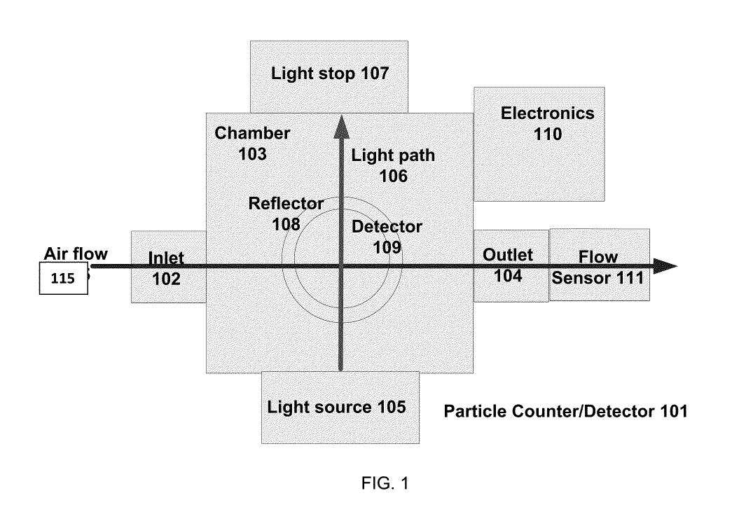

Referring now to FIG. 1, a particle or particulate counter/detector (101) is shown. The Particle Counter/Detector (101) includes all the basic elements required. The actual design is only inferred and actual implementation can vary substantially and does not limit the scope of the present invention. The counter/detector (101) includes a chamber (103) within which particulate detection occurs. An airstream or airflow path (115) to be sampled passes through the chamber (103) entering at the inlet (102) and exiting at the outlet (104). In particle counters the air flow rate is also measured by a flow sensor (111) in order to determine the velocity of particles (in order to sort them) and determine the volume of air sampled (in order to determine particle concentrations). A light source (105), typically a laser but high-intensity LEDs are also possible candidates, is directed through the airflow path (115). The light source is absorbed by a light-stop (107) in order to prevent light bouncing around inside the chamber (103) and causing false readings. Particulates in the airstream (115) will deflect the light source (105) as the particulates pass through the light path (106). This reflected light will be detected by a detector (109), typically a photo-detector. In some designs a reflector (108) is added to gather more of the reflected light and focus it on the detector (109), thereby increasing the light the detector (109) sees for a particulate event. The detector (109) and reflector (108) are mounted opposite each other in the vertical plane.

Electronics (110) provide the amplification of the very small detector signal. The electronics (110) can also provide the drive and conditioning needed for the light source (105), as well as providing the sensor and signal conditioning for the flow sensor (111). In accordance with the various aspects of the invention, the electronics (111) also provide the processing required to convert this information into particle counting/detecting. This could be implemented in a single board, or in a number of boards. The counter/detector (101) and the details provided therewith are simply meant to give a basic overview of particle counting/detecting and do not limit the scope of the invention as it is no intended to exclude any particular particle counter architecture.

Given some particle counter/detector module many variations and embodiments for integration into either portable or stationary respirators are possible. Some of these are described below, and for the sake of simplicity all of the particle counter/detectors in the examples will simply be referred to as particle detectors, but this is not meant to exclude particle counting embodiments from these examples:

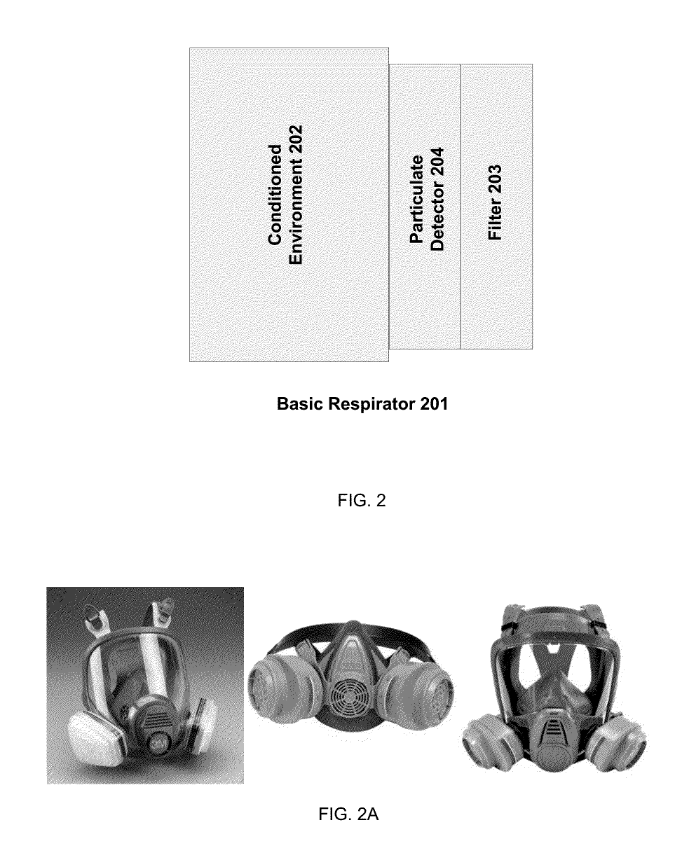

Referring now to FIG. 2, a block diagram representation of a respirator (201) is shown. A simple embodiment comprises a passive respirator assembly (no pumps, re-breathers, or compressed air tanks). In such an embodiment the user would provide the motive force for air movement (through respiration). By breathing, the user moves air in and out of the conditioned environment (202), a mask in most cases, though it can comprise a complete helmet or even a bubble. The air passes through the filter element (203). This assortment is standard in most existing low-end respirator products. By adding a particle detector (204), the product can monitor the air on the conditioned side (202) of the filter element (203) as it passes through this module and detect particulates present in that air. Elevated particulate levels could be used to indicate the condition or performance of the respirator (201), such as failure in either the respirator filtration or in the respirator fit (since poor fit would result in outside air circumventing filtration).

Referring now to FIG. 2A, shown are example of respirators that can be used to implement the various aspects of the present invention. The particle detector (204) can be added to any of the respirators for the purpose of testing the respirator before use, or it can be integrated into the respirator (201) as an in-situ assembly.

Referring again to FIG. 2 and FIG. 2A, the particle detector (204), could be designed into a molded assembly in such a manner as to mate with a particular or specific respirator model or family. As there are a finite number of filter unit footprints, a handful of molded parts could contain the particle detector (204) for large segment of the market. In accordance with one aspect of the invention, the particle detector (204) would be molded in such a way as to enable affixing it to the respirator in the place of one (or both, if two particle detector modules were used) of the filter (203) units. The particle detector (204) would also be molded in such a way as to receive the filter unit on the other end. This architecture would therefore make no changes to the existing respirator designs and would allow the particle detector (204) to be in-line with the airflow (on at least one filter path).

In accordance with some aspects of the invention, the unit might have a simple display element like a status LED (e.g. blinking green okay, blinking red fault or failure). The rate the LED blinked could roughly indicate the particulate density. The “display” could also include an LED bar with multiple green segments, and some yellow and or red segments. It could also be an LCD display with a bar graph, graph etc. There could be an external knob (or an internal pot or digital pot) to set the sensitivity of the detector (204). This could either be adjusted by the user during normal operation (to account for variations in environments, or within the environment) or it could be setup during fit testing, or calibrated at the factory (or some combination thereof, a value set during calibration with a smaller variation range accessible by the user). The electronics would likely be battery operated, with the unit going into sleep mode when the mask is not in use, or a switch could be used to enable/disable the electronics.

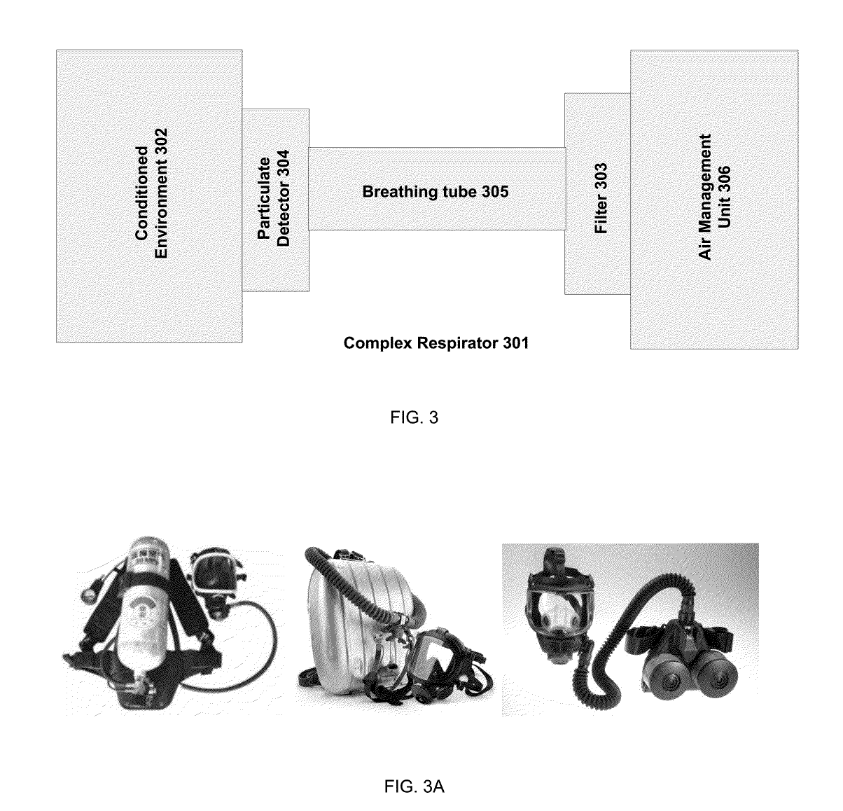

Referring now to FIG. 3, a complex respirator (301) is shown: Some of the higher-end respirators include compressed air tanks, re-breathers, etc. and can have built-in electronics and power-packs. Typically there are two separate units. One of these comprises the conditioned environment (302), and the other an air management unit (306). The air management unit (306) could include of one or more compressed air tanks, or an air re-breather (designed to scrub the exhaled air of CO2 etc. so that cleaned air could be re-used). These units are typically connected by a tube (305), or hose. In the case of compressed air tanks this might also include a regulator (not shown). Some of these systems also can also have filtration (303) which might be installed on either end of the breathing tube (305). In accordance with some aspects and embodiments of the invention, the particle detector (304) could also be installed on either end of the tube (305), either before or after the filter (303).

The electronics might be identical to that discussed in the basic respirator above, or it could be interface to electronics already in place in the complex respirator. This might include deriving power from such electronics and communicating status and reading information to these electronics. Such communication might be discrete digital signals, analog signals or processed values and readings over a communication interface (e.g. serial asynch, spi, i2c, etc.)

Referring now to FIG. 3A, some examples of more complex respirators is shown. As in the basic respirator, and now referring also to FIG. 3, the particle detector (304) in the complex respirator (301) could be molded in such a way as to interface to existing respirators without these requiring any changes. It could for example connect to one side of the breathing tube (305) and the other side of the particle detector (304) connects to either the controlled environment (302) portion of the unit or to the air management unit (306). It should be placed before the filter so that the air that is sampled is the air present in the controlled environment (302). Such units are typically positively pressurized which makes the fit a bit less of an issue (since any gaps are typically filled by escaping air), but even positively pressurized units can still admit outside air during respiration if the positive pressures are small.

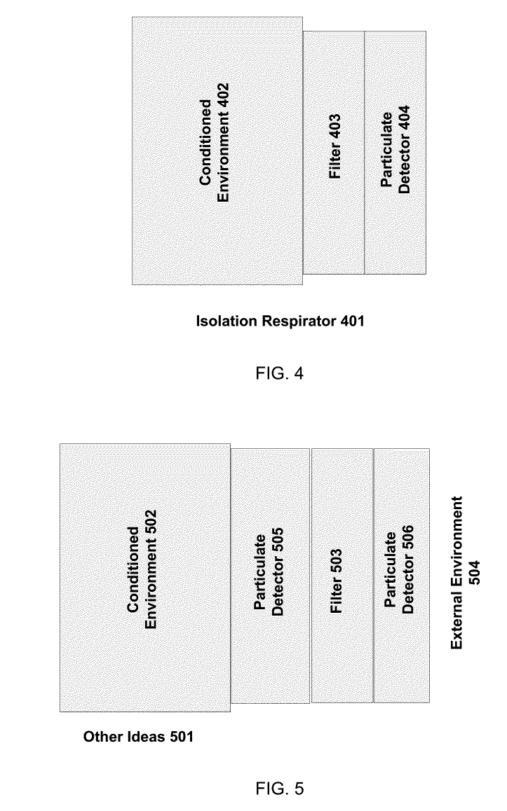

Referring now to FIG. 4, an isolation respirator (401) is shown that is used in applications where the respiration unit is designed to filter air from the user and to exhaust cleaned air into the environment. Applications for this include units used in isolation rooms where patients with severely compromised immune systems are kept. They might also include cutting edge cleanrooms where tiny particulates expelled from by users can impact wafer yields through contamination. In accordance with some aspects and embodiment of the invention, in these applications the particle detector (404) is placed between the filter (403) and the external environment, so that the air that is monitored is the air in the external environment. The air in the conditioned environment (402) passes through the filter (403) before reaching the particle detector (404), so that the particle detector (404) is measuring particulates exhausted into the room as opposed to particulates in the controlled environment (402). Thus, the particle detector (404) may be detecting readings present in the room as opposed to simply measuring the exhausted air. This is especially the case where the particle detector (404) sees airflow for both inhalation (air passing from the room to the controlled environment) and exhalation (air passing from the controlled environment to the room). To minimize counts present during inhalation a number of options are possible.

One embodiment is to use a one-way valve in series with the particle detector (404) so that only exhaled air passes through the particle detector (404), for inhalation the air would pass through a separate path in parallel with the particle detector (404). Another embodiment would measure the air flow rate (and direction) and only detect particles when the air was flowing in the desired direction (in this case during exhalation).

In accordance with the various aspects and embodiments of the invention, stationary respirators can be treated in the same way as the portable units we've been discussing. They can be either basic or complex respirators, as per the descriptions above. Having an integrated particle detector in such a unit can provide all the same benefits as in the portable units. In stationary units is more likely that there will be electronics and power already associated with the respirator and the interface to/from these would be more along the lines of the more complex integrated electronics discussed in the complex respirator section, though this doesn't eliminate the option of providing the simpler self-contained electronics options of the basic respirator unit.

Referring now to FIG. 5, a unit or system 501 is shown that includes dual particle detectors (505,506). In addition to the above ideas, the invention includes variations or additions that could be used to implement new embodiments. For example, having two particle detectors in a system (505,506) would allow a user to monitor both the external (504) and internal (502) environments. These could both be self-contained units with discrete electronics and displays or communication capabilities. For example they could both have adjustment knobs or “displays” as previously described. This would allow the user to get an indication of particulates in the external environment (504), perhaps to get an indication as to when it was safe to remove a respirator or where a safe location was for people they were rescuing or moving (in the case of rescue personnel). It would also give an indication of how well the respirator was functioning.

Such a design might require that existing filter elements be redesigned (for basic respirators) since in order to provide airflow across the external particle detector (505) it would need to be in the air flow path. Though an assembly that captured the filter element and ensured that routed air passed through both detectors is a viable option and wouldn't require any changes to the filter element.

In the case of implementing multiple particle detectors in complex respirators (which can provide positive airflow) a portion of the airflow could be diverted and channeled through the external particulate detector (506) to move air from the external environment (504) through the external particle detector (506). This could be done without a change to the existing respirator design.

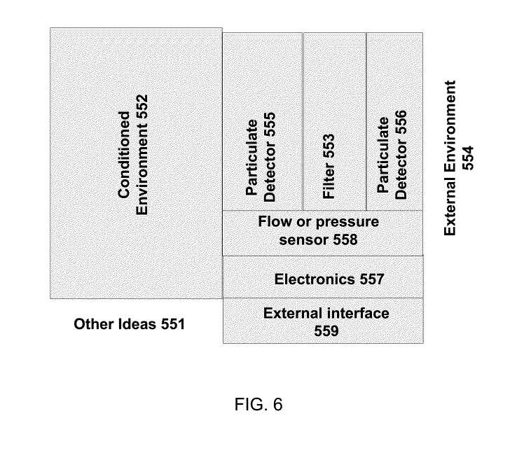

Referring now to FIG. 6, a unit or system (551), similar to the system of FIG. 5, is shown that includes additional features. By adding a flow sensor (558) across the filter (553) element the unit (551) can determine flow rate and with that information turn a particle detector (555 and or 556) into a particle counter (by allowing better sizing of particulates and better estimates of particulate concentrations).

If the sensor across the filter (553) element measures differential pressure (558) it could be used to determine filter loading (as filters become loaded they restrict the flow and therefore we see larger pressure drops across them over time). This can give a user (or service personnel) and indication as to when to change or service the filter (553).

Electronics (557) could be used to link (or implement most of the circuitry for) both particle detectors (555,556), and even to capture the flow or pressure sensor interface (558). Electronics (557) would drive down the cost of implementing such a system and also provide opportunities to integrate all of the sensors/detectors (555,556,558) in ways to provide synergistic functionality. The electronics (557) might all be implemented on a single printed circuit board, or perhaps on several interconnected boards. The electronics (557) can also include communication modules to allow information to be communicated from the unit (551) to remote devices.

Some examples of synergy, might be to process all of the data and convert readings and counts into digital format and communicate such using an external interface (559) to an external local system. This external local system might be the local controller for the respirator, which might already have a display available for a user, something mounted on the respirator or regulator apparatus, or even a heads-up display projected inside the mask, which would provide readily accessible information to the user even in environments with extreme levels of particulates. The external interface (559) could be a wide range of wired interfaces (e.g. serial asynch, usb, proprietary, etc) or wireless interfaces (e.g. Bluetooth, WiFi, proprietary, etc.)

The information could also be transmitted from the electronics (557) through the external interface (559) to some external system. In this case the interface would likely be wireless (e.g. WiFi, cellular, proprietary, etc.). The external system might be a monitoring system that could be used to track personnel and conditions from a remote site (incident center outside a disaster or rescue site). The staff could then monitor both the environment and personnel (and with the addition of GPS) get a view of conditions within the site and perhaps better inform and direct personnel during the operation. Thus, in accordance with the aspects of the invention, any embodiment can include communication module that allows wireless communication with remote devices or systems or servers.

It will be apparent that various aspects of the invention as related to certain embodiments may be implemented in software, hardware, application logic, or a combination of software, hardware, and application logic. The software, application logic and/or hardware may reside on a server, an electronic device, or be a service. If desired, part of the software, application logic and/or hardware may reside on an electronic device and part of the software, application logic and/or hardware may reside on a remote location, such as server.

In accordance with the teaching of the invention and certain embodiments, a program or code may be noted as running on a computing device, instrument, or unit. The computing device is an article of manufacture. Examples of an article of manufacture include: an instrument, a system, a unit, a server, a mainframe computer, a mobile telephone, a multimedia-enabled smartphone, a tablet computer, a personal digital assistant, a personal computer, a laptop, or other special purpose computer each having one or more processors (e.g., a controller, a Central Processing Unit (CPU), a Graphical Processing Unit (GPU), or a microprocessor) that is configured to execute a computer readable program code (e.g., an algorithm, hardware, firmware, and/or software) to receive data, transmit data, store data, or perform methods. The article of manufacture (e.g., computing device) includes memory that can be volatile or non-volatile. The memory, according to one aspect, is a non-transitory computer readable medium having a series of instructions, such as computer readable program steps encoded therein.

In accordance with aspects and certain embodiments of the invention, the non-transitory computer readable medium includes one or more data repositories. The non-transitory computer readable medium includes corresponding computer readable program code and may include one or more data repositories. Processors access the computer readable program code encoded on the corresponding non-transitory computer readable mediums and execute one or more corresponding instructions.

Other hardware and software components and structures are also contemplated. Unless defined otherwise, all technical and scientific terms used herein have the same meaning as commonly understood by one of ordinary skill in the art to which this invention belongs. Although any methods and materials similar or equivalent to those described herein can also be used in the practice or testing of the invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or system in connection with which the publications are cited. The citation of any publication is for its disclosure prior to the filing date and should not be construed as an admission that the invention is not entitled to antedate such publication by virtue of prior invention. Further, the dates of publication provided may be different from the actual publication dates which may need to be independently confirmed.

All statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the invention, therefore, is not intended to be limited to the exemplary embodiments shown and described herein. Rather, the scope and spirit of invention is embodied by the appended claims.

1. An apparatus comprising:
a respirator; and
a particle counter, the particle counter being operably connected to the respirator in the air flow path.
